(19) United States
(12) Patent Application Publication
(10) Pub. No.: US 2024/0185762 A1
(43) Pub. Date: Jun. 6, 2024

(54) ELECTRONIC DEVICE AND METHOD FOR SYNCHRONIZING TIMING OF PROCESSING COMMANDS FOR CONTROLLING DISPLAY PANEL

(71) Applicant: SAMSUNG ELECTRONICS CO., LTD., Suwon-si (KR)

(72) Inventors: Yohan LEE, Suwon-si (KR); Jongkon BAE, Suwon-si (KR); Yisoo WON, Suwon-si (KR); Jaesung LEE, Suwon-si (KR); Kwangtai KIM, Suwon-si (KR); Donghyun YEOM, Suwon-si (KR)

(21) Appl. No.: 18/437,677

(22) Filed: Feb. 9, 2024

Related U.S. Application Data
(63) Continuation of application No. PCT/KR2022/009130, filed on Jun. 27, 2022.

(30) Foreign Application Priority Data
Aug. 17, 2021 (KR) 10-2021-0108377
Dec. 20, 2021 (KR) 10-2021-0182377

(51) Int. Cl. G09G 3/20

(52) U.S. Cl. CPC G09G 3/2096; G09G 2340/0407

(57) ABSTRACT

An electronic device may comprise: at least one processor, comprising processing circuitry, a display panel, and a display driving circuit configured to: display an image through a display panel controlled using first commands by providing the first commands to a register in the display driving circuit in response to the first commands obtained from the at least one processor; defer providing second commands to the register until obtaining a designated request from at least one processor in response to the second commands obtained from the at least one processor; and display an image through the display panel controlled using the second commands by providing the second commands to the register based on a designated request obtained from the at least one processor.

### CROSS-REFERENCE TO RELATED APPLICATIONS

This application is a continuation of International Application No. PCT/KR2022/009130 designating the United States, filed on Jun. 27, 2022, in the Korean Intellectual Property Receiving Office and claiming priority to Korean Patent Application Nos. 10-2021-0108377, filed on Aug. 17, 2021, and 10-2021-0182377, filed on Dec. 20, 2021, in the Korean Intellectual Property Office, the disclosures of each of which are incorporated by reference herein in their entireties.

### BACKGROUND

### Field

The disclosure relates to an electronic device and method for synchronizing a timing of processing commands for controlling a display panel.

### Description of Related Art

An electronic device such as a smartphone, a tablet PC, and a smart watch may display various contents such as an image and text through a display panel. The display panel may be driven through a display driving integrated circuitry. Through each of a plurality of pixels configuring the display panel, the display driving integrated circuitry may display contents through the display panel controlled based on commands obtained from a processor in the electronic device.

### SUMMARY

According to an example embodiment, an electronic device is provided. The electronic device may include: at least one processor, comprising processing circuitry, a display panel, and a display driving integrated circuitry coupled with each of at least one processor and the display panel. The display driving integrated circuitry may be configured to, in response to obtaining first commands from the at least one processor, control the display to display, by providing the first commands to a register in the display driving integrated circuitry, an image through the display panel configured to be controlled using the first commands. The display driving integrated circuitry may be configured to, in response to obtaining second commands from the at least one processor, defer providing the second commands to the register until obtaining a designated request from the at least one processor. The display driving integrated circuitry may be configured to control the display to display, by providing the second commands to the register based on obtaining the designated request from the at least one processor, an image through the display panel configured to be controlled using the second commands.

According to an example embodiment, a method for operating an electronic device with at least one processor, comprising processing circuitry, a display panel, and a display driving integrated circuitry is provided. The method may comprise, in response to obtaining first commands from the at least one processor, displaying, by providing the first commands to a register in the display driving integrated circuitry, an image through the display panel controlled using the first commands. The method may comprise, in response to obtaining second commands from the at least one processor, deferring providing the second commands to the register until obtaining a designated request from the at least one processor. The method may comprise displaying, by providing the second commands to the register based on obtaining the designated request from the at least one processor, an image through the display panel controlled using the second commands.

According to various example embodiments, an electronic device and a method can prevent and/or reduce a malfunction from occurring in a display panel of the electronic device, by deferring providing commands to a register until a designated request is received from a processor.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an electronic device in a network environment, according to various embodiments.

FIG. 2 is a block diagram of a display module, according to various embodiments.

FIG. 3 is a simplified block diagram of an electronic device, according to an embodiment.

FIG. 4 is a simplified block diagram of a display driving integrated circuitry in an electronic device, according to an embodiment.

FIG. 5 is a timing diagram illustrating a method of providing commands to a register in response to obtaining the commands from a processor.

FIG. 6 illustrates an example of a flow in which commands stored in a buffer in a display driving integrated circuitry are provided to a register.

FIG. 7 illustrates another example of a flow in which commands stored in a buffer in a display driving integrated circuitry are provided to a register.

FIG. 8 is a timing diagram illustrating a method of providing commands to a register in response to obtaining a designated request from a processor.

FIG. 9 is a timing diagram illustrating a method of providing commands to a register based on a start timing of a vertical synchronization signal immediately following obtaining a designated request from a processor.

FIG. 10 is a timing diagram illustrating a method of providing commands to a register based on a designated command obtained from a processor after obtaining a designated request from the processor.

FIG. 11 is a timing diagram illustrating another method of providing commands to a register based on a designated command obtained from a processor after obtaining a designated request from the processor.

FIG. 12 is a timing diagram illustrating a method of providing commands to a register after a predefined time elapses from a timing obtaining a designated request from a processor.

FIG. 13 is a timing diagram illustrating a method of providing commands to a register after a predefined time elapses from a timing obtaining a designated command from a processor after obtaining a designated request from the processor.

FIG. 14 is a timing diagram illustrating a method of providing a first set of commands and a second set of commands to a register based on different timing.

FIG. 15 is a flowchart illustrating a method of deferring commands obtained from a processor.

### DETAILED DESCRIPTION

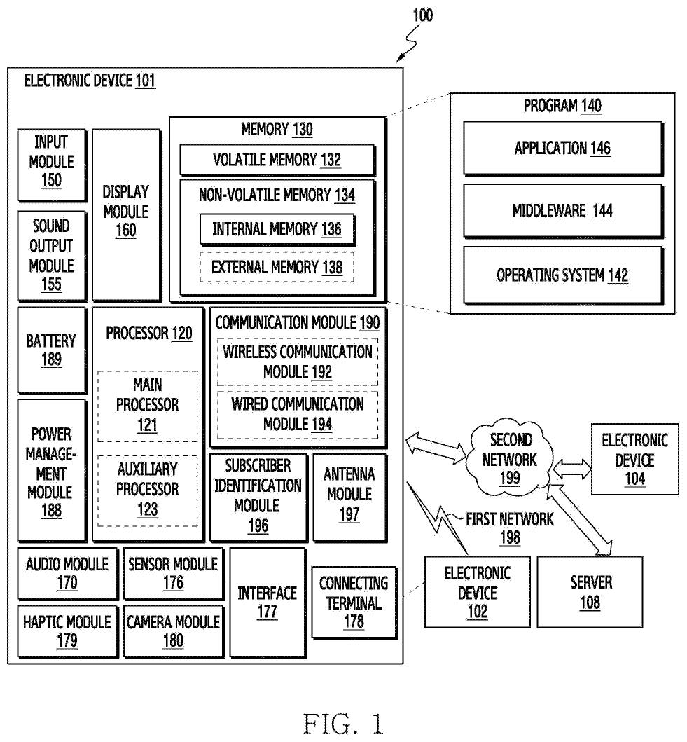

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

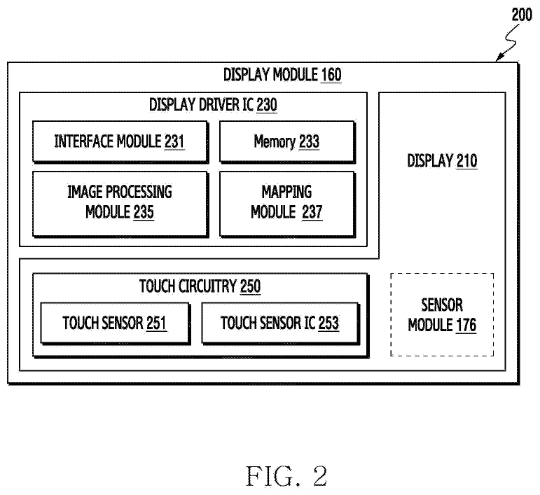

FIG. 2 is a block diagram 200 illustrating the display module 160 according to various embodiments.

Referring to FIG. 2, the display module 160 may include a display 210 and a display driver integrated circuit (DDI) 230 to control the display 210. The DDI 230 may include an interface module (e.g., including interface circuitry) 231, memory 233 (e.g., buffer memory), an image processing module (e.g., including image processing circuitry) 235, and/or a mapping module (e.g., including various circuitry) 237. The DDI 230 may receive image information that contains image data or an image control signal corresponding to a command to control the image data from another component of the electronic device 101 via the interface module 231. For example, according to an embodiment, the image information may be received from the processor 120 (e.g., the main processor 121 (e.g., an application processor)) or the auxiliary processor 123 (e.g., a graphics processing unit) operated independently from the function of the main processor 121. The DDI 230 may communicate, for example, with touch circuitry 250 or the sensor module 176 via the interface module 231. The DDI 230 may also store at least part of the received image information in the memory 233, for example, on a frame by frame basis. The image processing module 235 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 210. The mapping module 237 may generate a voltage value or a current value corresponding to the image data pre-processed or post-processed by the image processing module 235. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 210 may be driven, for example, based at least in part on the voltage value or the current value such that visual information (e.g., a text, an image, or an icon) corresponding to the image data may be displayed via the display 210.

According to an embodiment, the display module 160 may further include touch circuitry 250. The touch circuitry 250 may include a touch sensor 251 and a touch sensor IC 253 to control the touch sensor 251. The touch sensor IC 253 may control the touch sensor 251 to sense a touch input or a hovering input with respect to a certain position on the display 210. To achieve this, for example, the touch sensor 251 may detect (e.g., measure) a change in a signal (e.g., a voltage, a quantity of light, a resistance, or a quantity of one or more electric charges) corresponding to the certain position on the display 210. The touch circuitry 250 may provide input information (e.g., a position, an area, a pressure, or a time) indicative of the touch input or the hovering input detected via the touch sensor 251 to the processor 120. According to an embodiment, at least part (e.g., the touch sensor IC 253) of the touch circuitry 250 may be formed as part of the display 210 or the DDI 230, or as part of another component (e.g., the auxiliary processor 123) disposed outside the display module 160.

According to an embodiment, the display module 160 may further include at least one sensor (e.g., a fingerprint sensor, an iris sensor, a pressure sensor, or an illuminance sensor) of the sensor module 176 or a control circuit for the at least one sensor. In such a case, the at least one sensor or the control circuit for the at least one sensor may be embedded in one portion of a component (e.g., the display 210, the DDI 230, or the touch circuitry 250)) of the display module 160. For example, when the sensor module 176 embedded in the display module 160 includes a biometric sensor (e.g., a fingerprint sensor), the biometric sensor may obtain biometric information (e.g., a fingerprint image) corresponding to a touch input received via a portion of the display 210. As another example, when the sensor module 176 embedded in the display module 160 includes a pressure sensor, the pressure sensor may obtain pressure information corresponding to a touch input received via a partial or whole area of the display 210. According to an embodiment, the touch sensor 251 or the sensor module 176 may be disposed between pixels in a pixel layer of the display 210, or over or under the pixel layer.

A processor in an electronic device may provide commands for controlling a display panel in the electronic device to a display driving integrated circuitry in the electronic device. The display driving integrated circuitry may obtain the commands from the processor and display an image through the display panel controlled based on the obtained commands.

Meanwhile, the electronic device may provide various modes in relation to displaying images through the display panel. For example, the electronic device may provide a first mode for displaying images having a first resolution and a second mode for displaying images having a second resolution different from the first resolution. For example, the processor may provide commands to the display driving integrated circuitry to switch the first mode to the second mode. The display driving integrated circuitry may process each of the commands to switch the first mode to the second mode. When processing of each of the commands is not synchronized, a malfunction may occur in the display panel.

The technical problems identified in this disclosure are not limited to those described above, and other technical problems not mentioned herein will be clearly understood by those having ordinary knowledge in the art to which the present disclosure belongs, from the following description.

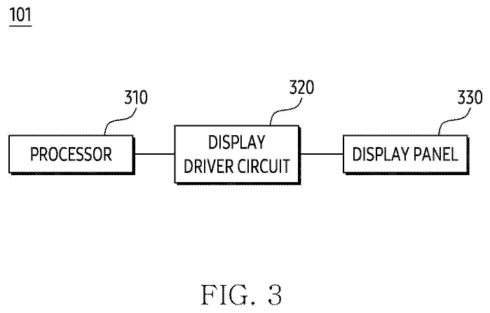

FIG. 3 is a simplified block diagram of an electronic device, according to an embodiment.

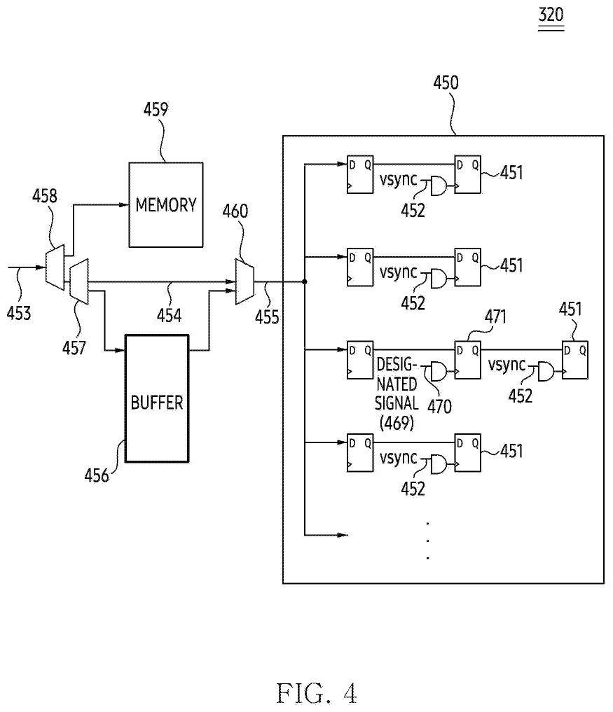

FIG. 4 is a simplified block diagram of a display driving integrated circuitry in an electronic device, according to an embodiment.

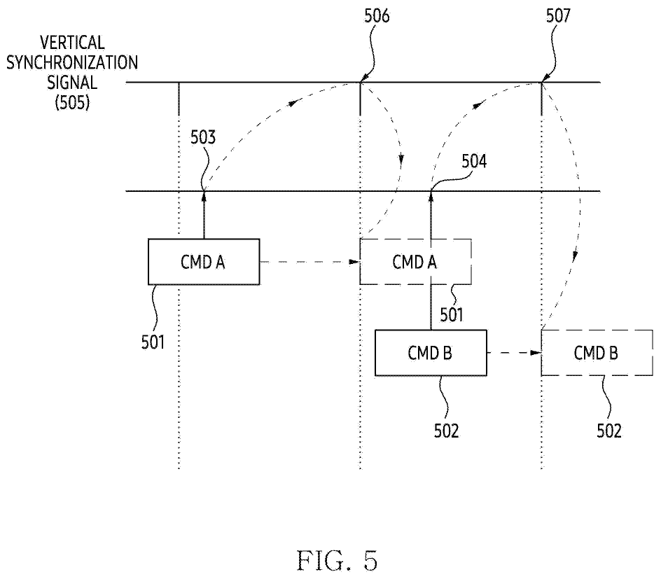

FIG. 5 is a timing diagram illustrating a method of providing commands to a register in response to obtaining the commands from a processor.

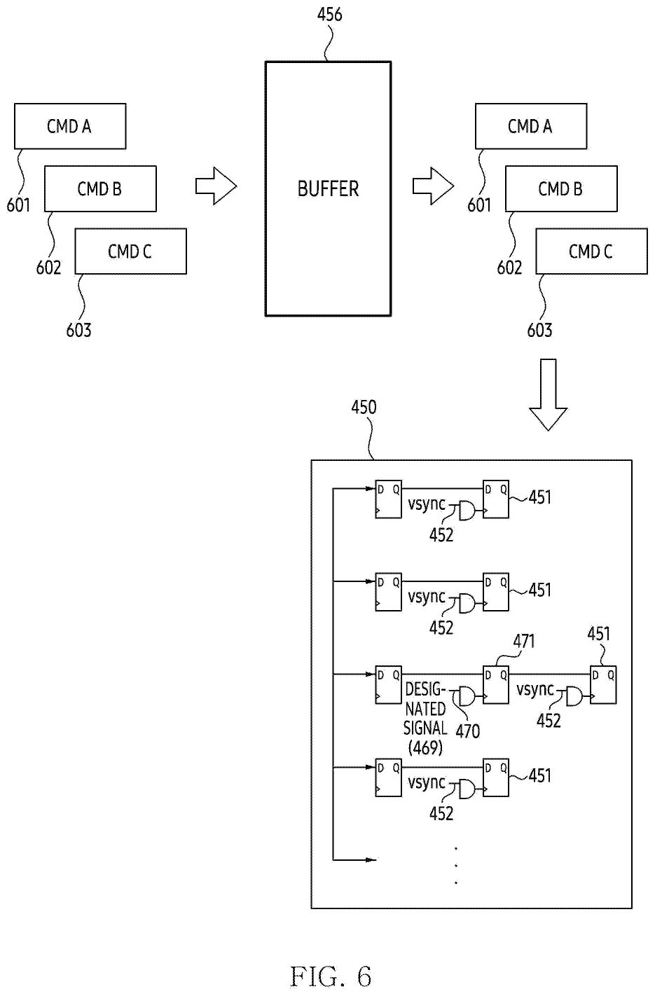

FIG. 6 illustrates an example of a flow in which commands stored in a buffer in a display driving integrated circuitry are provided to a register.

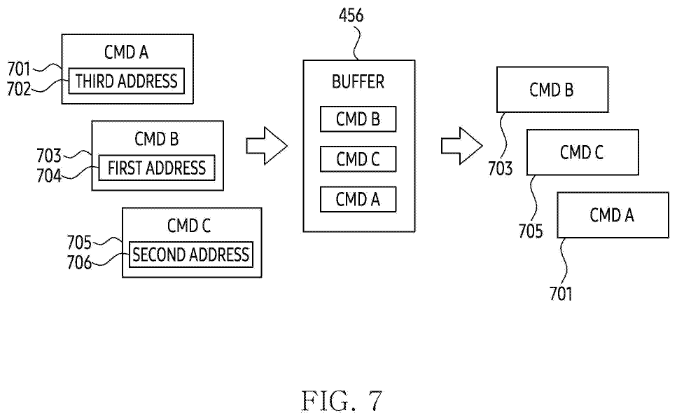

FIG. 7 illustrates another example of a flow in which commands stored in a buffer in a display driving integrated circuitry are provided to a register.

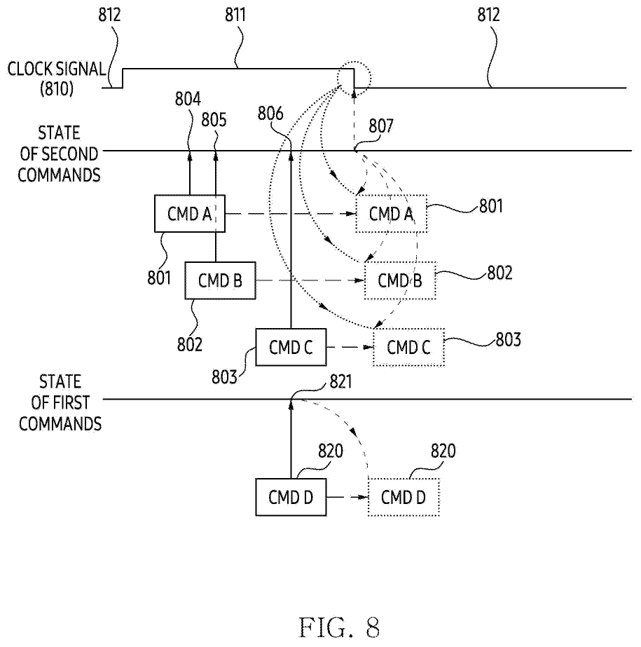

FIG. 8 is a timing diagram illustrating a method of providing commands to a register in response to obtaining a designated request from a processor.

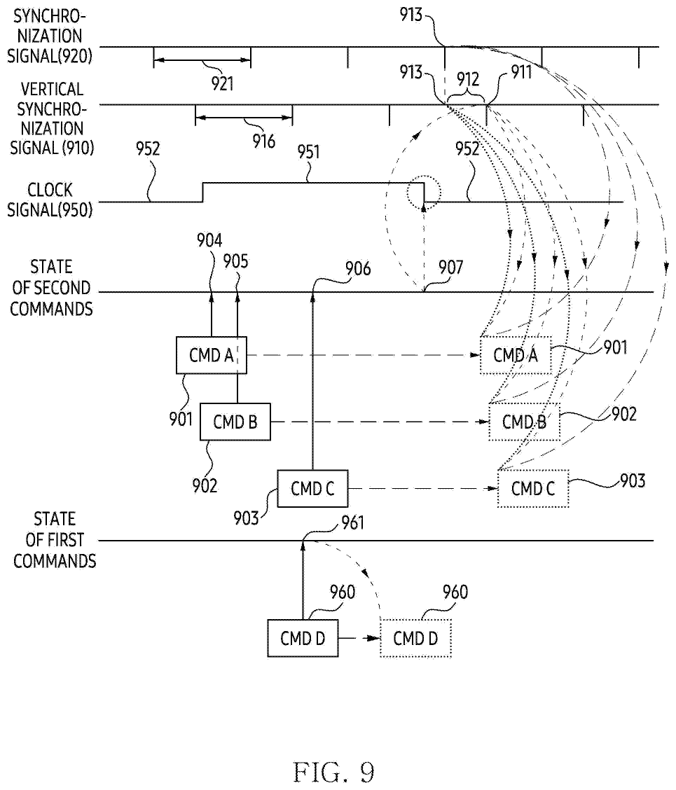

FIG. 9 is a timing diagram illustrating a method of providing commands to a register based on a start timing of a vertical synchronization signal immediately following obtaining a designated request from a processor.

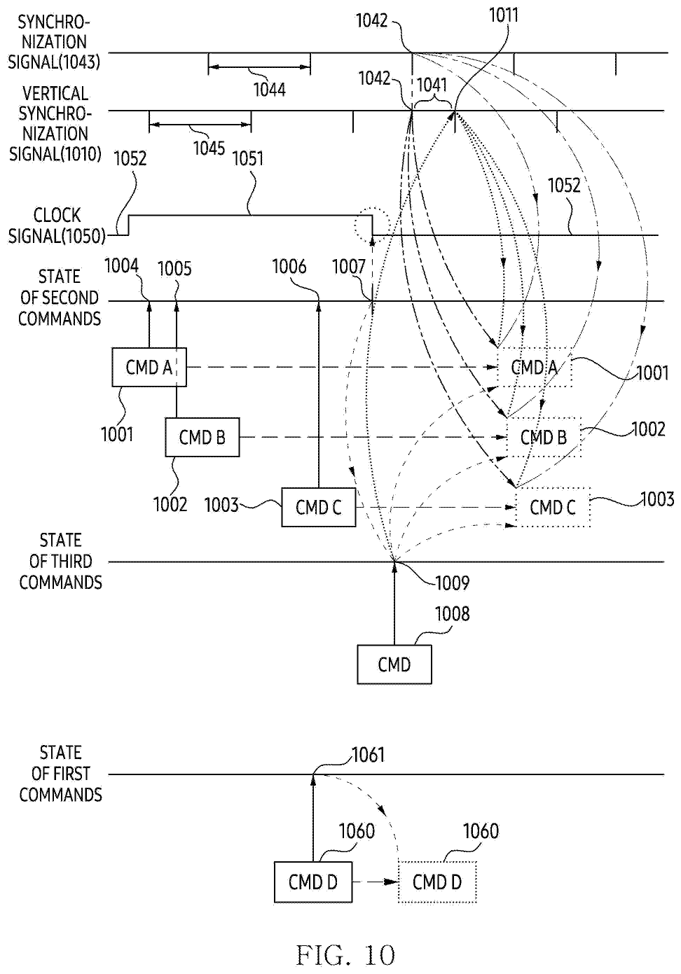

FIG. 10 is a timing diagram illustrating a method of providing commands to a register based on a designated command obtained from a processor after obtaining a designated request from the processor.

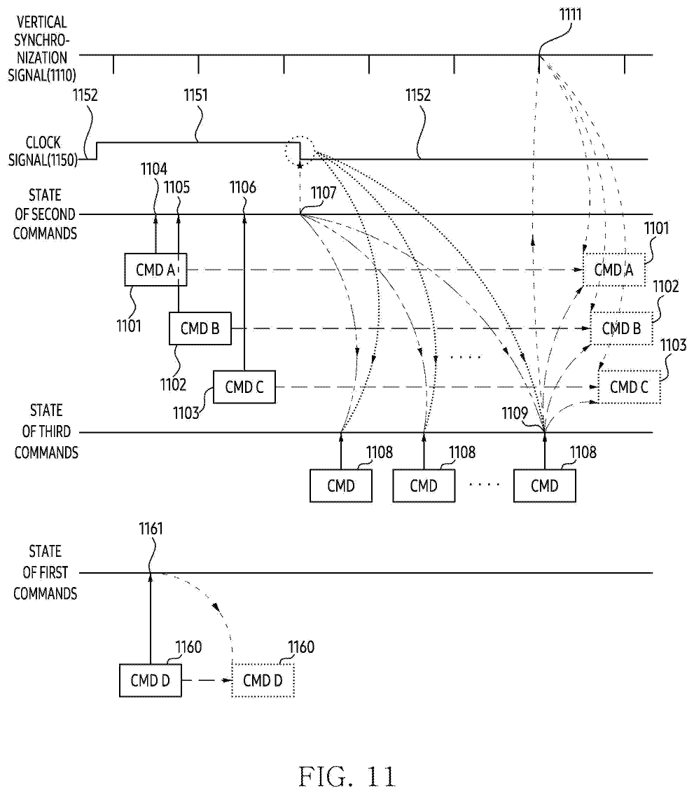

FIG. 11 is a timing diagram illustrating another method of providing commands to a register based on a designated command obtained from a processor after obtaining a designated request from the processor.

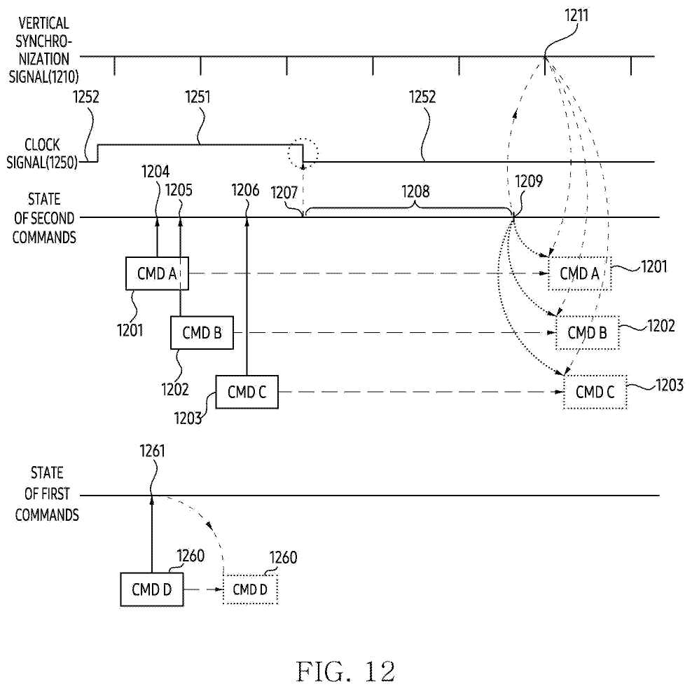

FIG. 12 is a timing diagram illustrating a method of providing commands to a register after a predefined time elapses from a timing obtaining a designated request from a processor.

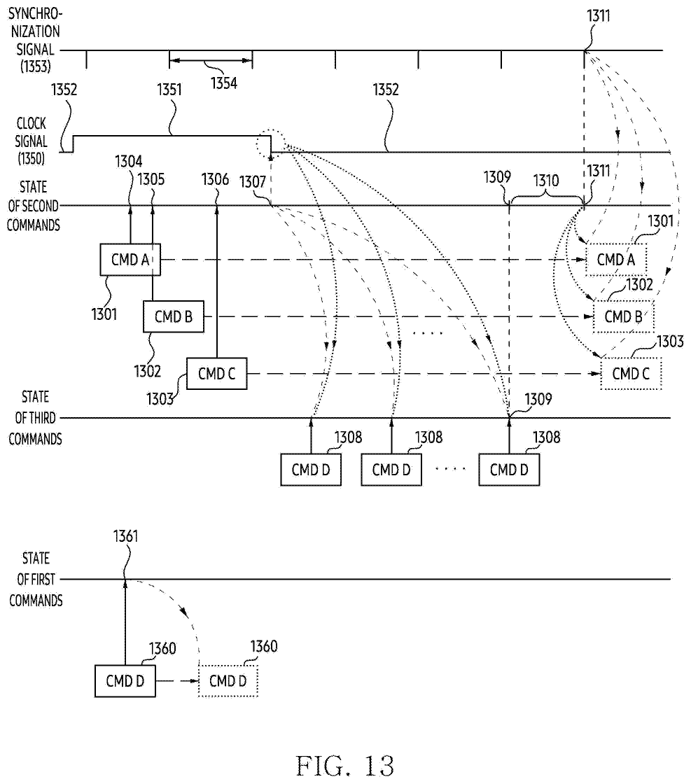

FIG. 13 is a timing diagram illustrating a method of providing commands to a register after a predefined time elapses from a timing obtaining a designated command from a processor after obtaining a designated request from the processor.

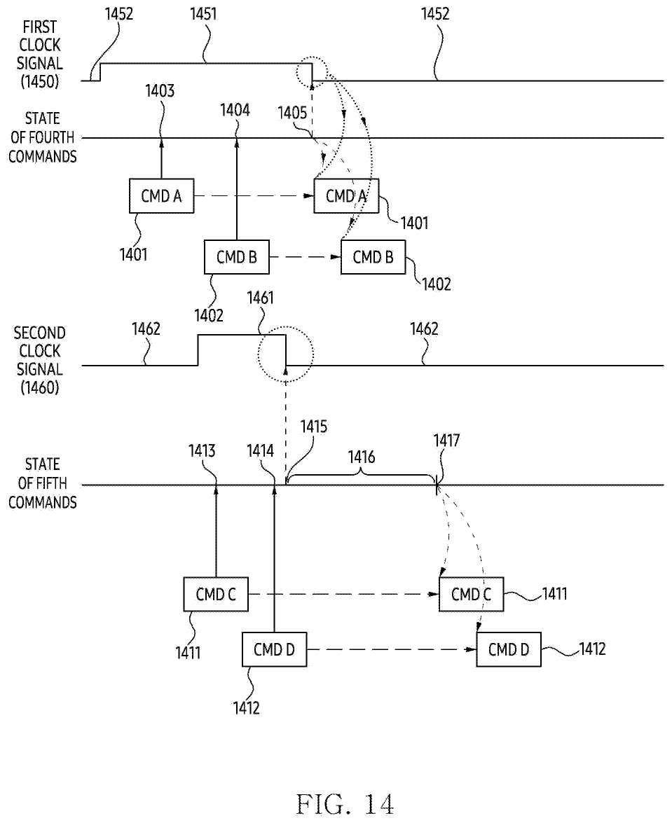

FIG. 14 is a timing diagram illustrating a method of providing a first set of commands and a second set of commands to a register based on different timing.

Referring to FIG. 3, an electronic device 101 may include a processor (e.g., including processing circuitry) 310, display driving integrated circuitry 320, and a display panel 330.

The processor 310 may include the processor 120 illustrated in FIG. 1. The processor 310 may be operably coupled with the display driving integrated circuitry 320. The display driving integrated circuitry 320 may include the DDI 230 illustrated in FIG. 2. The display driving integrated circuitry 320 may be operably coupled with the display panel 330. The display panel 330 may include the display 210 illustrated in FIG. 2. The processor 310 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In various embodiments, the display driving integrated circuitry 320 may obtain commands from the processor 310. For example, the commands may be provided from the processor 310 through various interfaces. For example, the commands may be provided from the processor 310 to the display driving integrated circuitry 320 through a mobile industry processor interface (MIPI), a mobile display digital interface (MDDI), a serial peripheral interface (SPI), an inter-integrated circuit (I2C), and/or a compact display port (CDP). However, it is not limited thereto.

In various embodiments, each of the commands may be used to control the display panel 330. For example, the commands may include commands used to change a state of the display panel 330 from a state of providing a black image to a state of providing another image distinct from the black image. For example, the commands may include commands used to set luminance of an image displayed through the display panel 330. For example, the commands may include commands used to set resolution of an image displayed through the display panel 330. However, it is not limited thereto.

In various embodiments, the display driving integrated circuitry 320 may display an image through the display panel 330 controlled based on the commands. In various embodiments, the display driving integrated circuitry 320 may control the display panel 330 based on processing the commands. In various embodiments, the display driving integrated circuitry 320 may provide the commands to a register in the display driving integrated circuitry 320, in order to control a timing processing each of the commands. For example, the register may be used to store the commands for controlling component of the display panel 330, respectively. For example, the register may include a plurality of flip-flops (or latch) capable of switching states based on a vertical synchronization signal (or a designated command, or another signal) for controlling a timing displaying an image through the display panel 330. For example, each of the plurality of flip-flops may have a first state for storing a command input to each of the plurality of flip-flops and a second state for outputting the stored command in response to obtaining the vertical synchronization signal. For example, referring to FIG. 4, a register 450 in the display driving integrated circuitry 320 may include a plurality of flip-flops 451. Each of the plurality of flip-flops 451 may output the stored command in response to obtaining the vertical synchronization signal through a terminal 452 while storing a command input to each of the plurality of flip-flops 451. The output command may be provided to components of the display panel 330. For example, the display driving integrated circuitry 320 may control a timing of processing the commands based on the vertical synchronization signal (or a designated command, or another signal), by providing each of the commands to each of the plurality of flip-flops 451.

On the other hand, the commands may include first commands that do not require all to be processed within a designated time interval (e.g., a display active interval between a front porch interval and a back porch interval of the vertical synchronization signal, or the front porch interval, or the back porch interval) and second commands that require all to be processed within the designated time interval. For example, when the second commands are not all processed within the designated time interval, unlike the first commands, the second commands may cause a malfunction within the display panel 330. For example, compared with the first commands, the second commands may be commands that require synchronizing with each other.

In various embodiments, the display driving integrated circuitry 320 may differently process the first commands and the second commands.

In an embodiment, the display driving integrated circuitry 320 may provide the first commands to the register in response to obtaining the first commands from the processor 310. For example, referring to FIGS. 4 and 5, the display driving integrated circuitry 320 may obtain a command A 501 and a command B 502, which are the first commands, through a path 453 from the processor 310. For example, the command A 501 may be obtained from the processor 310 through the path 453 at a timing 503, and the command B 502 may be obtained from the processor 310 through the path 453 at a timing 504. The display driving integrated circuitry 320 may provide the command A 501 to a flip-flop among the plurality of flip-flops 451 through paths 454 and 455 in response to obtaining the command A 501 at the timing 503 or immediately after obtaining the command A 501 at the timing 503, and may provide the command B 502 to another flip-flop among the plurality of flip-flops 451 through the path 454 and the path 455 in response to obtaining the command B 502 at the timing 504 or immediately after obtaining the command B 502 at the timing 504. The command A 501 provided to the flip-flop may be output from the flip-flop at a timing 506 (e.g., immediately following the timing 503) at which the vertical synchronization signal 505 starts immediately (or rightly) after the timing 503, and the command B 502 provided to the flip-flop may be output from the other flip-flop at a timing 507 (e.g., immediately following the timing 504) at which the vertical synchronization signal 505 states immediately following the timing 504. For example, the timing 506 at which the command A 501 is output from the flip-flop may be controlled by the display driving integrated circuitry 320 based on the vertical synchronization signal 505, but the timing 503 may not be controlled by the display driving integrated circuitry 320, because the timing 503 is identified by the processor 310. As another example, the timing 507 at which the command B 502 is output from the other flip-flop is controlled by the display driving integrated circuitry 320 based on the vertical synchronization signal 505, but the timing 504 may not be controlled by the display driving integrated circuitry 320, because the timing 504 is identified by the processor 310. Since the display driving integrated circuitry 320 may not control the timing 503 and the timing 504, a timing controlling the display panel 330 based on the command A 501 and a timing controlling the display panel 330 based on the command B 502 may not be synchronized with each other. Since the command A 501 and the command B 502, which are the first commands, do not require to be processed together within the designated time interval, even when the command A 501 and the command B 502 are not synchronized with each other, a malfunction may not occur in the display panel 330.

In an embodiment, the display driving integrated circuitry 320 may defer, in response to obtaining the second commands from the processor 310, providing the second commands to the register until obtaining a designated request from the processor 310, and provide the second commands to the register based on obtaining the designated request from the processor 310. For example, the designated request may be provided from the processor 310 to the display driving integrated circuitry 320, in order to indicate that providing all of the second commands to be processed within the designated time interval to the display driving integrated circuitry 320 is completed. For example, referring to FIG. 4, the display driving integrated circuitry 320 may obtain the second commands from the processor 310 through the path 453. In response to obtaining the second commands, the display driving integrated circuitry 320 may defer providing the second commands to the register 450 by storing the second commands in a buffer 456 instead of providing the second commands to register 450 via the path 454 and the path 455. For example, the display driving integrated circuitry 320 may identify commands obtained from the processor 310 as the first commands or the second commands using a first command control unit (e.g., including circuitry) 457, may provide the first commands to the register 450 via the path 454 and the path 455, and may provide the second commands to the buffer 456. For example, the display driving integrated circuitry 320 may identify a state of a flag in the commands obtained from the processor 310 using the first command control unit 457, may provide commands identified as the first commands to the register 450 via the path 454 and the path 455 by identifying the commands as the first commands based on identifying that the state of the flag is a first state, and may provide commands identified as the second commands to the buffer 456 by identifying the commands as the second commands based on identifying that the state of the flag is a second state different from the first state using the first command control unit 457. For another example, the display driving integrated circuitry 320 may obtain a signal for indicating a time interval providing the second commands from the processor 310, and may provide commands identified as the first commands via the path 454 and the path 455 to the register 450 by identifying the commands obtained outside the time interval indicated by the signal as the first commands using the first command control unit 457, and provide commands identified as the second commands to the buffer 456 by identifying the commands obtained within the time interval indicated by the signal as the second commands using the first command control unit 457. However, it is not limited thereto.

On the other hand, the display driving integrated circuitry 320 may further include a second command control unit (e.g., including circuitry) 458 for identifying third commands for controlling a memory 459 (e.g., graphical random access memory (GRAM)) among the commands before identifying the commands obtained from the processor 310 as the first commands or the second commands. For example, the third commands may include commands for indicating that a transmission of frame data is started. For example, the third commands may be used to store the frame data obtained from the processor 310 in the memory 459 in the display driving integrated circuitry 320. However, it is not limited thereto.

On the other hand, the display driving integrated circuitry 320 may further include a third command control unit (e.g., including circuitry) 460 for controlling a timing providing each of the first commands and the second commands to the register 450. For example, the display driving integrated circuitry 320 may control the timing providing each of the first commands and the second commands to the register 450 using the third command control unit 460, so that a timing providing the first commands to the register 450 does not overlap a timing providing the second commands to the register 450.

On the other hand, order in which the second commands stored in the buffer 456 are provided to the register 450 based on obtaining the designated request may be defined in various ways.

In an embodiment, the order in which the second commands stored in the buffer 456 are provided to the register 450 based on obtaining the designated request may be identified based on order stored in the buffer 456. For example, a second command of the second commands stored in the buffer 456 before a first command is stored in the buffer 456 of the second commands may be provided to the register 450 before the first command based on obtaining the designated request. For example, the second commands stored in the buffer 456 may be provided to the register 450 according to first in first out (FIFO). For example, referring to FIG. 6, the display driving integrated circuitry 320 may store a command A 601, which is a command of the second commands obtained from the processor 310, in the buffer 456, may store a command B 602, which is another command of the second commands obtained from the processor 310, in buffer 456 after storing the command A 601 in the buffer 456, and may store a command C 603, which is still another command of the second commands obtained from the processor 310, in the buffer 456 after storing the command A 601 and the command B 602 in the buffer 456. Based on obtaining the designated request, the display driving integrated circuitry 320 may provide the command A 601 first stored in the buffer 456 among the command A 601, the command B 602, and the command C 603 to the register 450, may provide the command B 602 to the register 450 after providing the command A 601 to the register 450, and may provide the command C 603 to the register 450 after providing the command A 601 and the command B 602. However, it is not limited thereto.

In an embodiment, order in which the second commands stored in the buffer 456 are provided to the register 450 based on obtaining the designated request may be identified based on information included in each of the second commands. For example, the information may be address information for indicating a location in which each of the second commands is to be stored in the register 450. For example, referring to FIG. 7, the display driving integrated circuitry 320 may store a command A 701, which is a command of the second commands obtained from the processor 310, in a third address of the buffer 456 indicated by address information 702 in the command A 701, may store a command B 703, which is another command of the second commands obtained from the processor 310, in a first address of the buffer 456 indicated by address information 704 in the command B 703, and may store a command C 705, which is still another of the second commands obtained from the processor 310, in a second address of the buffer 456 indicated by address information 706 in the command C 705. Based on obtaining the designated request, the display driving integrated circuitry 320 may first provide the command B 703 stored in the first address among the command A 701, the command B 703, and the command C 705 to the register 450, may provide the command C 705 stored in the second address, which is an address following the first address, to the register 450 after providing the command B 703, and may provide the command A 701 stored in the third address, which is an address following the second address, to the register 450 after providing the command B 703 and the command C 705. However, it is not limited thereto.

On the other hand, a timing at which the second commands are provided to the register 450 based on obtaining the designated request may be variously defined.

In an embodiment, the display driving integrated circuitry 320 may provide the second commands to the register 450 in response to obtaining the designated request or immediately after obtaining the designated request. For example, referring to FIG. 8, the display driving integrated circuitry 320 may obtain the second commands including a command A 801, a command B 802, and a command C 803, from the processor 310. For example, the display driving integrated circuitry 320 may obtain the command A 801 at a timing 804, the command B 802 at a timing 805, and the command C 803 at a timing 806. In response to obtaining the command A 801, the command B 802, and the command C 803, the display driving integrated circuitry 320 may defer providing the command A 801, the command B 802, and the command C 803 to the register 450 until obtaining the designated request from the processor 310. For example, in response to obtaining the command A 801, the command B 802, and the command C 803, the display driving integrated circuitry 320 may defer providing the command A 801, the command B 802, and the command C 803 to the register 450 by storing the command A 801, the command B 802, and the command C 803 in the buffer 456, instead of providing the command A 801, the command B 802, and the command C 803 to the register 450. The display driving integrated circuitry 320 may obtain the designated request from the processor 310 at a timing 807, while storing the command A 801, the command B 802, and the command C 803 in the buffer 456. The display driving integrated circuitry 320 may provide the command A 801, the command B 802, and the command C 803 to the register 450 to the register 450, in response to obtaining the designated request at the timing 807 or immediately after obtaining the designated request at the timing 807. Although not shown in FIG. 8, in an embodiment, on a condition that processing of a part among the command A 801, the command B 802, and the command C 803 may not be synchronized with processing of another part among the command A 801, the command B 802, and the command C 803 when the command A 801, the command B 802, and the command C 803 are provided to the register 450 immediately after obtaining the designated request, the display driving integrated circuitry 320 may provide the command A 801, the command B 802, and the command C 803 to the register 450 after a predefined time elapses from the timing 807 obtaining the designated request. In an embodiment, in order to distinguish between a state of storing the second commands including the command A 801, the command B 802, and the command C 803 in the buffer 456 and a state of providing the second commands including the command A 801, the command B 802, and the command C 803 stored in the buffer 456 to the register 450, a clock signal 810 may be defined in the display driving integrated circuitry 320. For example, the clock signal 810 may be referred to as a flag signal 810. For example, the clock signal 810 may be defined within the display driving integrated circuitry 320 to control a timing providing the second commands to the register 450. In an embodiment, a state of the clock signal 810 may be controlled by the processor 310. However, it is not limited thereto. For example, the display driving integrated circuitry 320 may defer providing the register 450 with the second commands including the command A 801, the command B 802, and the command C 803 obtained while the clock signal 810 is in a first state 811. In response to obtaining the designated request at timing the 807, the display driving integrated circuitry 320 may switch a state of the clock signal 810 from the first state 811 to a second state 812, and may provide each of the second commands including the command A 801, the command B 802, and the command C 803 to the register 450 based on the state of the clock signal 810 switched from the first state 811 to the second state 812. However, it is not limited thereto. On the other hand, the display driving integrated circuitry 320 may obtain a command D 820, which is a command among the first commands, from the processor 310 at a timing 821. The display driving integrated circuitry 320 may provide the command D 820 to the register 450 in response to obtaining the command D 820 at the timing 821. For example, since the command D 820 is a command of the first commands, it may be provided to the register 450 immediately after being obtained by the display driving integrated circuitry 320, unlike the second commands including the command A 801, the command B 802, and the command C 803. For example, the display driving integrated circuitry 320 may provide the register 450 with each of the first commands including the command D 820 immediately after obtaining each of the first commands including the command D 820, independently before the state of the clock signal 810. For example, even when the command D 820 is obtained while the clock signal 810 is in the second state 812 unlike the illustration of FIG. 8, the display driving integrated circuitry 320 may provide the command D 820 to the register 450 immediately after obtaining the command D 820 as illustrated in FIG. 8.

In an embodiment, the display driving integrated circuitry 320 may provide the second commands to the register 450 based on a start timing of a vertical synchronization signal immediately following obtaining the designated request. For example, referring to FIG. 9, the display driving integrated circuitry 320 may obtain the second commands including a command A 901, a command B 902, and a command C 903, from the processor 310. For example, the display driving integrated circuitry 320 may obtain the command A 901 at a timing 904, the command B 902 at a timing 905, and the command C 903 at a timing 906. In response to obtaining the command A 901, the command B 902, and the command C 903, the display driving integrated circuitry 320 may defer providing the command A 901, the command B 902, and the command C 903 to the register 450 until obtaining the designated request from the processor 310. For example, instead of providing the register 450 with the command A 901, the command B 902, and the command C 903 in response to obtaining the command A 901, the command B 902, and the command C 903, the display driving integrated circuitry 320 may defer providing the command A 901, the command B 902, and the command C 903 to the register 450, by storing the command A 901, the command B 902, and the command C 903 in the buffer 456. The display driving integrated circuitry 320 may obtain the designated request from the processor 310 at a timing 907 while storing the command A 901, the command B 902, and the command C 903 in the buffer 456. The display driving integrated circuitry 320 may provide the command A 901, the command B 902, and the command C 903 to the register 450 based on a start timing 911 of a vertical synchronization signal 910 immediately following the timing 907 obtaining the designated request. For example, the display driving integrated circuitry 320 may initiate providing the register 450 with the second commands including the command A 901, the command B 902, and the command C 903 at a timing 913 before a predefined a time 912 from the start timing 911 of the vertical synchronization signal 910. For example, the predefined time 912 may be a time interval defined to secure a time for processing all of the second commands within the designated time interval. In an embodiment, the predefined time 912 may be defined to complete providing the register 450 with the second commands including the command A 901, the command B 902, and the command C 903 before the start timing 911 of the vertical synchronization signal 910. For example, the predefined time 912 may not be applied on a condition that securing time to complete providing the second commands is not required. However, it is not limited thereto. For example, in order to identify the timing 913 before the predefined time 912 from the start timing 911 of the vertical synchronization signal 910, a synchronization signal 920 may be defined within the display driving integrated circuitry 320. For example, the synchronization signal 920 may start at a timing (e.g., the timing 913) before a predefined time (e.g., the predefined time 912) from a start timing (e.g., the start timing 911) of the vertical synchronization signal 910. For example, a period 921 of the synchronization signal 920 may be the same as a period 916 of the vertical synchronization signal 910. For example, the display driving integrated circuitry 320 may initiate providing the register 450 with the second commands including the command A 901, the command B 902, and the command C 903, based on the timing 913, which is a start timing of the synchronization signal 920 immediately following the timing 907 obtaining the designated request. In an embodiment, each of a length of the predefined time 912 and a length of the period 921 of the synchronization signal 920 may be changed. For example, each of the length of the predefined time 912 and the length of the period 921 of the synchronization signal 920 may be changed based on a number of the second commands stored in the buffer 456. However, it is not limited thereto. In an embodiment, a clock signal 950 may be defined in the display driving integrated circuitry 320 to distinguish between a state of storing the second commands including the command A 901, the command B 902, and the command C 903 in the buffer 456 and a state of providing the second commands including the command A 901, the command B 902, and the command C 903, which are stored in the buffer 456, to register 450. For example, the clock signal 950 may be defined within the display driving integrated circuitry 320 to control a timing providing the second commands to the register 450. For example, the clock signal 950 may correspond to the clock signal 810 illustrated in FIG. 8. For example, the display driving integrated circuitry 320 may defer providing the register 450 with the second commands including the command A 901, the command B 902, and the command C 903, which are obtained while the clock signal 950 is in a first state 951. The display driving integrated circuitry 320 may switch a state of the clock signal 950 from the first state 951 to a second state 952 in response to obtaining the designated request at the timing 907, may identify the timing 913 based on the state of the clock signal 950 switched from the first state 951 to the second state 952, and may provide each of the second commands including the command A 901, the command B 902, and the command C 903 to the register 450 at the timing 913. However, it is not limited thereto. On the other hand, the display driving integrated circuitry 320 may provide the register 450 with a command D 960 in response to obtaining a command D 960, which is a command of the first commands, at the timing 961. For example, unlike the second commands including the command A 901, the command B 902, and the command C 903, since the command D 960 is a command of the first commands, it may be provided to the register 450 immediately after being obtained by the display driving integrated circuitry 320. For example, the display driving integrated circuitry 320 may provide the register 450 with each of the first commands including the command D 960 immediately after obtaining each of the first commands including the command D 960, independently of the state of the clock signal 950. For example, even when the command D 960 is obtained while the clock signal 950 is in the second state 952 unlike the illustration of FIG. 9, the display driving integrated circuitry 320 may provide the command D 960 to the register 450 immediately after obtaining the command D 960, as illustrated in FIG. 9.

In an embodiment, the display driving integrated circuitry 320 may provide the second commands to the register 450 after obtaining the designated request from the processor 310, based on obtaining a command (e.g., a command of the third commands) for indicating that a transmission of frame data from the processor 310 is started. For example, referring to FIG. 10, the display driving integrated circuitry 320 may obtain the second commands including a command A 1001, a command B 1002, and a command C 1003, from the processor 310. For example, the display driving integrated circuitry 320 may obtain the command A 1001 at a timing 1004, the command B 1002 at a timing 1005, and the command C 1003 at a timing 1006. In response to obtaining the command A 1001, the command B 1002, and the command C 1003, the display driving integrated circuitry 320 may defer providing the command A 1001, the command B 1002, and the command C 1003, to the register 450, until obtaining the designated request from the processor 310. For example, instead of providing to the register 450 with the command A 1001, the command B 1002, and the command C 1003 in response to obtaining the command A 1001, the command B 1002, and the command C 1003, the display driving integrated circuitry 320 may defer providing the register 450 with the command A 1001, the command B 1002, and the command C 1003, by storing the command A 1001, the command B 1002, and the command C 1003 in the buffer 456. The display driving integrated circuitry 320 may obtain the designated request from the processor 310 at a timing 1007 while storing the command A 1001, the command B 1002, and the command C 1003, in the buffer 456. The display driving integrated circuitry 320 may identify whether obtaining a command 1008 for indicating that a transmission of frame data from the processor 310 is started based on obtaining the designated request at the timing 1007. For example, the command 1008 may be a command provided to the memory 459 through the second command control unit 458. In response to obtaining the command 1008 at a timing 1009, the display driving integrated circuitry 320 may provide the register 450 with the command A 1001, the command B 1002, and the command C 1003. In an embodiment, the command A 1001, the command B 1002, and the command C 1003, may be provided to the register 450, based on a timing 1011 at which a vertical synchronization signal 1010 immediately following the timing 1009 obtaining the command 1008 from the processor 310 is started. In an embodiment, the command A 1001, the command B 1002, and the command C 1003 may be provided to the register 450 based on a timing 1042 before a predefined time 1041 from the start timing 1011 of the vertical synchronization signal 1010 immediately following the timing 1009 obtaining the command 1008 from the processor 310. For example, the predefined time 1041 may be a time interval defined to secure a time for processing all of the second commands within the designated time interval. In an embodiment, the predefined time 1041 may be defined to complete providing the register 450 with the second commands including the command A 1001, the command B 1002, and the command C 1003 before the start timing 1011 of the vertical synchronization signal 1010. For example, the predefined time 1041 may not be applied on a condition that securing time to complete providing the second commands is not required. In an embodiment, in order to identify the timing 1042 before the predefined time 1041 from the start timing 1011 of the vertical synchronization signal 1010, a synchronization signal 1043 may be defined within the display driving integrated circuitry 320. For example, the synchronization signal 1043 may be started at the timing 1042 before the predefined time 1041 from the start timing 1011 of the vertical synchronization signal 1010. For example, a period 1044 of the synchronization signal 1043 may be the same as a period 1045 of the vertical synchronization signal 1010. In an embodiment, each of a length of the predefined time 1041 and a length of the period 1044 of the synchronization signal 1043 may be changed. For example, each of the length of the predefined time 1041 and the length of the period 1044 of the synchronization signal 1043 may be changed based on a number of the second commands stored in the buffer 456. However, it is not limited thereto.

In an embodiment, a clock signal 1050 may be defined in the display driving integrated circuitry 320 in order to distinguish between a state of storing the second commands including the command A 1001, the command B 1002, and the command C 1003 in the buffer 456 and a state of providing the second commands including the command A 1001, the command B 1002, and the command C 1003 to the register 450, which are stored in the buffer 456. For example, the clock signal 1050 may correspond to the clock signal 810. For example, the display driving integrated circuitry 320 may defer providing the register 450 with the second commands including the command A 1001, the command B 1002, and the command C 1003, which are obtained while the clock signal 1050 is in a first state 1051. The display driving integrated circuitry 320 may switch a state of the clock signal 1050 from the first state 1051 to a second state 1052 in response to obtaining the designated request at the timing 1007, and may identify whether obtaining the command 1008 from the processor 310 based on the state of the clock signal 1050 switched from the first state 1051 to the second state 1052. In response to obtaining the command 1008 from the processor 310 while the state of the clock signal 1050 is in the second state 1052, the display driving integrated circuitry 320 may provide the register 450 with each of the second commands including the command A 1001, the command B 1002, and the command C 1003. However, it is not limited thereto. On the other hand, in response to obtaining a command D 1060, which is a command of the first commands at a timing 1061, the display driving integrated circuitry 320 may provide the command D 1060 to the register 450. For example, unlike the second commands including the command A 1001, the command B 1002, and the command C 1003, since the command D 1060 is a command of the first commands, it may be provided to the register 450 immediately after being obtained by the display driving integrated circuitry 320. For example, the display driving integrated circuitry 320 may provide the register 450 with each of the first commands including the command D 1060, immediately after obtaining each of the first commands including the command D 1060, independently of the state of the clock signal 1050. For example, even when the command D 1060 is obtained while the clock signal 1050 is in the second state 1052 unlike the illustration of FIG. 10, the display driving integrated circuitry 320 may provide the command D 1060 to the register 450 immediately after obtaining the command D 1060, as illustrated in FIG. 10.

In an embodiment, after obtaining the designated request from the processor 310, the display driving integrated circuitry 320 may identify whether a number of commands (e.g., a command of the third commands), which are obtained from the processor, for indicating that a transmission of frame data is started reaches a designated number, and provide the second commands to the register 450 based on identifying that the number of commands reaches the designated number. For example, referring to FIG. 11, the display driving integrated circuitry 320 may obtain the second commands including a command A 1101, a command B 1102, and a command C 1103 from the processor 310. For example, the display driving integrated circuitry 320 may obtain the command A 1101 at a timing 1104, the command B 1102 at a timing 1105, and the command C 1103 at a timing 1106. In response to obtaining the command A 1101, the command B 1102, and the command C 1103, the display driving integrated circuitry 320 may defer providing the command A 1101, the command B 1102, and the command C 1103 to the register 450, until obtaining the designated request from the processor 310. For example, instead of providing the register 450 with the command A 1101, the command B 1102, and the command C 1103 in response to obtaining the command A 1101, the command B 1102, and the command C 1103, the display driving integrated circuitry 320 may defer providing the command A 1101, the command B 1102, and the command C 1103 to the register 450 by storing the command A 1101, the command B 1102, and the command C 1103 in the buffer 456. The display driving integrated circuitry 320 may obtain the designated request from the processor 310 at a timing 1107 while storing the command A 1101, the command B 1102, and the command C 1103 in the buffer 456. Based on obtaining the designated request at the timing 1107, the display driving integrated circuitry 320 may identify whether a number of commands 1108, which are obtained from the processor 310, for indicating that a transmission of frame data is started reaches a designated number. For example, based on identifying that the number of the commands 1108 obtained from the processor 310 reaches the designated number at a timing 1109, the display driving integrated circuitry 320 may provide the command A 1101, the command B 1102, and the command C 1103 to the register 450. In an embodiment, the command A 1101, the command B 1102, and the command C 1103 may be provided to register 450, based on a timing 1111 at which a vertical synchronization signal 1110 is started immediately following the timing 1109 identifying that the number of commands 1108 obtained from the processor 310 reaches the designated number. However, it is not limited thereto. In an embodiment, a clock signal 1150 may be defined in the display driving integrated circuitry 320, in order to distinguish between a state of storing the second commands including the command A 1101, the command B 1102, and the command C 1103 in the buffer 456 and a state of providing the register 450 with the second commands including the command A 1101, the command B 1102, and the command C 1103 stored in the buffer 456. For example, the clock signal 1150 may correspond to the clock signal 810. For example, the display driving integrated circuitry 320 may defer providing the register 450 with the second commands including the command A 1101, the command B 1102, and the command C 1103, which are obtained while the clock signal 1150 is in a first state 1151. The display driving integrated circuitry 320 may switch a state of the clock signal 1150 from the first state 1151 to a second state 1152 in response to obtaining the designated request at the timing 1107, and identify whether the number of the commands 1108 obtained from the processor 310 reaches the designated number based on the state of the clock signal 1150 switched from the first state 1151 to the second state 1152. Based on identifying that the number of the commands 1108 obtained from the processor 310 while the state of the clock signal 1150 is in the second state 1152 reaches the designated number, the display driving integrated circuitry 320 may provide the register 450 with each of the second commands including the command A 1101, the command B 1102, and the command C 1103. However, it is not limited thereto. On the other hand, the display driving integrated circuitry 320 may provide the register 450 with a command D 1160 in response to obtaining the command D 1160, which is a command of the first commands, from the timing 1161. For example, unlike the second commands including the command A 1101, the command B 1102, and the command C 1103, since the command D 1160 is a command of the first commands, it may be provided to the register 450 immediately after being obtained by the display driving integrated circuitry 320. For example, the display driving integrated circuitry 320 may provide the register 450 with each of the first commands including the command D 1160, immediately after obtaining each of the first commands including the command D 1160, independently of the state of the clock signal 1150. For example, even when the command D 1160 is obtained while the clock signal 1150 is in the second state 1152, unlike the illustration of FIG. 11, the display driving integrated circuitry 320 may provide the register 450 with the command D 1160 immediately after obtaining the command D 1160, as illustrated in FIG. 11.

In an embodiment, the display driving integrated circuitry 320 may provide the second commands to the register 450 after a predefined time elapses from a timing obtaining the designated request from the processor 310. For example, the predefined time may be a time interval defined to secure a time for processing all of the second commands within the designated time. For example, referring to FIG. 12, the display driving integrated circuitry 320 may obtain the second commands including a command A 1201, a command B 1202, and a command C 1203 from the processor 310. For example, the display driving integrated circuitry 320 may obtain the command A 1201 at a timing 1204, the command B 1202 at a timing 1205, and the command C 1203 at a timing 1206. In response to obtaining the command A 1201, the command B 1202, and the command C 1203, the display driving integrated circuitry 320 may defer providing the register 450 with the command A 1201, the command B 1202, and the command C 1203 until obtaining the designated request from the processor 310. For example, instead of providing the register 450 with the command A 1201, the command B 1202, and the command C 1203 in response to obtaining the command A 1201, the command B 1202, and the command C 1203, the display driving integrated circuitry 320 may defer providing the register 450 with the command A 1201, the command B 1202, and the command C 1203 by storing the command A 1201, the command B 1202, and the command C 1203 in the buffer 456. The display driving integrated circuitry 320 may obtain the designated request from the processor 310 at a timing 1207 while storing the command A 1201, the command B 1202, and the command C 1203 in the buffer 456. The display driving integrated circuitry 320 may provide the register 450 with the command A 1201, the command B 1202, and the command C 1203, based on a timing 1209 at which a predefined time 1208 elapses from the timing 1207 obtaining the designated request from the processor 310. For example, the predefined time 1208 may be a time interval defined to secure a time for processing all of the second commands within the designated time. In an embodiment, the display driving integrated circuitry 320 may provide the register 450 with the command A 1201, the command B 1202, and the command C 1203, based on a timing 1211 at which a vertical synchronization signal 1210 immediately following the timing 1209 is started. However, it is not limited thereto. In an embodiment, a clock signal 1250 may be defined in the display driving integrated circuitry 320, in order to distinguish between a state of storing the second commands including the command A 1201, the command B 1202, and the command C 1203 in the buffer 456 and a state of providing the register 450 with the second commands including the command A 1201, the command B 1202, and the command C 1203, which are stored in the buffer 456. For example, the clock signal 1250 may correspond to the clock signal 810. For example, the display driving integrated circuitry 320 may defer providing the register 450 with the second commands including the command A 1201, the command B 1202, and the command C 1203, which are obtained while the clock signal 1250 is in a first state 1251. The display driving integrated circuitry 320 may switch a state of the clock signal 1250 from the first state 1251 to a second state 1252 in response to obtaining the designated request at the timing 1207, and may provide the register 450 with each of the second commands including the command A 1201, the command B 1202, and the command C 1203, at the timing 1209 at which the predefined time 1208 elapses from a timing 1207 switching the state of the clock signal 1250 to the second state 1252. However, it is not limited thereto. On the other hand, in response to obtaining the command D 1260, which is a command of the first commands, at a timing 1261, the display driving integrated circuitry 320 may provide the command D 1260 to the register 450. For example, unlike the second commands including the command A 1201, the command B 1202, and the command C 1203, since the command D 1260 is a command of the first commands, it may be provided to the register 450 immediately after being obtained by the display driving integrated circuitry 320. For example, the display driving integrated circuitry 320 may provide the register 450 with each of the first commands including the command D 1260, immediately after obtaining each of the first commands including the command D 1260, independently of the state of the clock signal 1250. For example, even when the command D 1260 is obtained while the clock signal 1250 is in the second state 1252 unlike the illustration of FIG. 12, the display driving integrated circuitry 320 may provide the register 450 with the command D 1260 immediately after obtaining the command D 1260, as illustrated in FIG. 12.

In an embodiment, the display driving integrated circuitry 320 may provide the second commands to the register 450 after a predefined time has elapsed from a timing of identifying that a number of commands (e.g., a command of the third commands) obtained from the command 310 for indicating that a transmission of frame data is started reaches a specified number, after obtaining the designated request from the processor 310. For example, the predefined time may be a time interval defined to secure a time for processing all of the second commands within the designated time. For example, referring to FIG. 13, the display driving integrated circuitry 320 may obtain the second commands including a command A 1301, a command B 1302, and a command C 1303, from the processor 310. For example, the display driving integrated circuitry 320 may obtain the command A 1301 at a timing 1304, the command B 1302 at a timing 1305, and the command C 1303 at a timing 1306. In response to obtaining the command A 1301, the command B 1302, and the command C 1303, the display driving integrated circuitry 320 may defer providing the register 450 with the command A 1301, the command B 1302, and the command C 1303 until obtaining the designated request from the processor 310. For example, instead of providing the register 450 with the command A 1301, the command B 1302, and the command C 1303 in response to obtaining the command A 1301, the command B 1302, and the command C 1303, The display driving integrated circuitry 320 may defer providing the register 450 with the command A 1301, the command B 1302, and the command C 1303 by storing the command A 1301, the command B 1302, and the command C 1303 in the buffer 456. The display driving integrated circuitry 320 may obtain the designated request from the processor 310 at a timing 1307 while storing the command A 1301, the command B 1302, and the command C 1303 in the buffer 456. Based on obtaining the designated request at the timing 1307, the display driving integrated circuitry 320 may identify whether a number of commands 1308 for indicating that a transmission of frame data is started reaches a designated number, which are obtained from the processor 310. The display driving integrated circuitry 320 may provide the register 450 with the command A 1301, the command B 1302, and the command C 1303 based on a timing 1311 at which a predefined time 1310 elapses from a timing 1309 identifying that a number of the commands 1308 reaches the designated number. In an embodiment, a clock signal 1350 may be defined in the display driving integrated circuitry 320 in order to distinguish between a state of storing the second commands including the command A 1301, the command B 1302, and the command C 1303 in the buffer 456 and a state of providing the register 450 with the second commands including the command A 1301, the command B 1302, and the command C 1303, which are stored in the buffer 456. For example, the clock signal 1350 may correspond to the clock signal 810. For example, the display driving integrated circuitry 320 may defer providing the register 450 with the second commands including the command A 1301, the command B 1302, and the command C 1303, which are obtained while the clock signal 1350 is in a first state 1351. The display driving integrated circuitry 320 may switch a state of the clock signal 1350 from the first state 1351 to a second state 1352 in response to obtaining the designated request at the timing 1307, and may identify whether a number of the commands 1308 obtained from the processor 310 based on the state of the clock signal 1350 switched from the first state 1351 to the second state 1352 reaches the designated number. The display driving integrated circuitry 320 may provide the register 450 with each of the second commands including the command A 1301, the command B 1302, and the command C 1303, based on the timing 1311 at which the predefined time 1310 elapses from the timing 1309 identifying that the number of commands 1308 obtained from the processor 310 while the state of the clock signal 1350 is in the second state 1352 reaches the designated number. For example, the predefined time 1310 may be a time interval defined to secure a time for processing all of the second commands within the designated time interval. In an embodiment, the predefined time 1310 may be defined to complete providing the second commands. In an embodiment, in order to identify the timing 1311 at which the predefined time interval 1310 elapses from the timing 1309, a synchronization signal 1353 may be defined in the display driving integrated circuitry 320. For example, the synchronization signal 1353 may be started at the timing 1311 at which the predefined time interval 1310 elapses from the timing 1309. For example, a period 1354 of the synchronization signal 1353 may be the same as a period of a vertical synchronization signal (not illustrated in FIG. 13). In an embodiment, each of a length of the predefined time 1310 and a length of the period 1354 of the synchronization signal 1353 may be changed. For example, each of the length of the predefined time 1310 and the length of the period 1354 of the synchronization signal 1353 may be changed based on the number of the second commands stored in the buffer 456. However, it is not limited thereto. On the other hand, the display driving integrated circuitry 320 may provide the register 450 with a command D 1360 in response to obtaining the command D 1360 at a timing 1361. For example, unlike the second commands including the command A 1301, the command B 1302, and the command C 1303, since command D 1360 is a command of the first commands, it may be provided to the register 450 immediately after being obtained by the display driving integrated circuitry 320. For example, the display driving integrated circuitry 320 may provide each of the first commands including the command D 1360 to the register 450, immediately after obtaining each of the first commands including the command D 1360, independently of the state of the clock signal 1350. For example, even when the command D 1360 is obtained while the clock signal 1350 is in the second state 1352 unlike the illustration of FIG. 13, the display driving integrated circuitry 320 may provide the register 450 with the command D 1360 immediately after obtaining the command D 1360, as illustrated in FIG. 13.

On the other hand, a part of the second commands may be provided to the register 450 on another condition distinct from a condition in which another part of the second commands is provided to the register 450. For example, fourth commands, which are a part of the second commands, may be provided to the register 450 in response to obtaining a designated request for indicating that providing the display driving integrated circuitry 320 with the fourth commands is completed from the processor 310, and fifth commands, which are another part of the second commands, may be provided to the register 450 after a predefined time elapses from a timing at which another designated request indicating that providing the display driving integrated circuitry 320 with the fifth commands is completed is obtained from the processor 310. In an embodiment, in order to identify the fourth commands and the fifth commands, different flags may be applied to the fourth commands and the fifth commands, respectively. However, it is not limited thereto.

For example, referring to FIG. 14, the display driving integrated circuitry 320 may obtain the fourth commands including a command A 1401 and a command B 1402 from the processor 310. For example, the display driving integrated circuitry 320 may obtain the command A 1401 at a timing 1403 and the command B 1402 at a timing 1404. The display driving integrated circuitry 320 may defer providing the register 450 with the command A 1401 and the command B 1402 by storing the command A 1401 and the command B 1402 in the buffer 456. The display driving integrated circuitry 320 may obtain the fifth commands including a command C 1411 and a command C 1412 from the processor 310 while storing the command A 1401 and the command B 1402 in the buffer 456. For example, the display driving integrated circuitry 320 may obtain the command C 1411 at a timing 1413 and the command D 1412 at a timing 1414. The display driving integrated circuitry 320 may defer providing the register 450 with the command C 1411 and the command C 1412, storing the command C 1411 and the command C 1412 in a buffer (e.g., the buffer 456, or another buffer) within the display driving integrated circuitry 320. For example, the command C 1411 and the command C 1412 may be stored in another buffer in display driving integrated circuitry 320 distinguished from the buffer 456. For another example, the command C 1411 and the command D 1412 may be stored in a second area of the buffer 456, which is distinguished from a first area of the buffer 456 in which the command A 1401 and the command B 1402 are stored. For example, the second area may be an area capable of storing the command C 1411 and the command D 1412, independently of providing the fourth commands including the command A 1401 and the command B 1402 stored in the first area to the register 450. However, it is not limited thereto. In an embodiment, the display driving integrated circuitry 320 may obtain a first designated request for indicating to provide the fourth commands including command A 1401 and command B 1402 to the register 450 from the processor 310 at the timing 1405. The display driving integrated circuitry 320 may provide the register 450 with the fourth commands including the command A 1401 and the command B 1402, in response to obtaining the first designated request at the timing 1405 or immediately after obtaining the first designated request at the timing 1405. Providing the fourth commands to the register 450 may be processed within the display driving integrated circuitry 320 independently of providing the fifth commands to the register 450. On the other hand, the display driving integrated circuitry 320 may obtain a second designated request for indicating to provide the fifth commands including the command C 1411 and the command C 1412 to the register 450 at a timing 1415, from the processor 310. Based on a timing 1417 at which a predefined time 1416 elapses from the timing 1415 obtaining the second designated request, the display driving integrated circuitry 320 may provide the fifth commands including the command C 1411 and the command C 1412 to the register 450. Providing the fifth commands to the register 450 may be processed within the display driving integrated circuitry 320 independently of providing the fourth commands to the register 450. In an embodiment, a first clock signal 1450 may be defined in the display driving integrated circuitry 320, in order to distinguish between a state of storing the fourth commands and a state of providing the stored fourth commands to the register 450. For example, the first clock signal 1450 may correspond to the clock signal 810. For example, the display driving integrated circuitry 320 may store the fourth commands including the command A 1401 and the command B 1402 obtained from the processor 310 while the first clock signal 1450 is in a first state 1451, may switch a state of the first clock signal 1450 from the first state 1451 to a second state 1452 in response to obtaining the first designated request at the timing 1405, and may provide each of the fourth commands including the command A 1401 and the command B 1402 to the register 450 in response to switching the state of the first clock signal 1450 to the second state 1452. On the other hand, a second clock signal 1460 may be defined in the display driving integrated circuitry 320, in order to process the fourth commands and the fifth commands independently and distinguish between a state storing the fifth commands and a state of providing the stored fifth commands to the register 450. For example, the second clock signal 1460 may correspond to the clock signal 810. For example, the display driving integrated circuitry 320 may store the fifth commands including the command C 1411 and the command C 1412 obtained from the processor 310 while the second clock signal 1460 is in a first state 1461, may switch a state of the second clock signal 1460 from the first state 1461 to a second state 1462 in response to obtaining the second designated request at the timing 1415, and may provide each of the fifth commands including the command C 1411 and the command C 1412 to the register 450 in response to identifying the timing 1417 at which the predefined time 1416 elapses from the timing 1415 switching the state of the second clock signal 1460 to the second state 1462.

FIG. 14 illustrates an example of providing the fourth commands to the register 450 immediately after obtaining the first designated request and providing the fifth commands to the register 450 based on the timing 1417 at which the predefined time 1416 elapses from the timing 1415 obtaining second designated request, but it is for convenience of explanation. It should be noted that various methods defined through the descriptions of FIGS. 8 to 13 may be used to provide each of the fourth commands and the fifth commands to the register 450.

FIG. 14 illustrates an example in which a time interval in which the first clock signal 1450 is in the first state 1451 partially overlaps a time interval in which the second clock signal 1460 is in the first state 1461, but the time interval in which the first clock signal 1450 is in the first state 1451 and the time interval in which the second clock signal 1460 is in the first state 1461 may be separated from each other.

On the other hand, when other commands to be stored in the buffer 456 are obtained from the processor 310 while providing commands stored in the buffer 456 to the register 450 based on obtaining the designated request by the display driving integrated circuitry 320, a part of the other commands may be provided to the register 450 together with the commands. In order to prevent and/or reduce a part of the other commands from being provided to the register 450 together with the commands, the display driving integrated circuitry 320 may provide the processor 310 with a first signal for preventing/reducing the other commands from being provided from the processor 310, in response to obtaining the designated request. For example, the first signal may include information for indicating to cease obtaining the other commands to be stored in the buffer 456 from processor 310. For example, the first signal may include information for indicating that the commands are being provided to the register 450. However, it is not limited thereto. In response to identifying that providing the commands to the register 450 is completed, the display driving integrated circuitry 320 may provide the processor 310 with a second signal for indicating to resume obtaining the other commands to be stored in the buffer 456 from the processor 310. For example, the first signal and the second signal may be defined to prevent and/or reduce damage of at least a part of the commands. However, it is not limited thereto.

In an embodiment, based on storing in the buffer 456 a designated command (or designated signal) for controlling a timing of outputting a command from a flip-flop in the register 450, the display driving integrated circuitry 320 may synchronize processing at least one of the first commands and processing the second commands. For example, referring to FIG. 4, the register 450 may include a flip-flop 471 configured to store commands until obtaining a designated signal 469 through a terminal 470 and output the stored commands in response to obtaining the designated signal 469 through the terminal 470. For example, while storing at least one of the first commands in the flip-flop 471, the display driving integrated circuitry 320 may store the designated signal 469 and the second commands to be synchronized with the at least one command in the buffer 456. The display driving integrated circuitry 320 may provide the designated signal 469 and the second commands from the buffer 456 to the register 450 in response to obtaining the designated request. Since the flip-flop 471 outputs the at least one command in response to obtaining the designated signal 469, the processing of the at least one command and the processing of the second commands may be synchronized with each other.

As described above, the display driving integrated circuitry 320 in the electronic device 101 may defer providing the second commands to the register 450 in the display driving integrated circuitry 320 until receiving a designated request from the processor 310, the second command capable of causing a malfunction within the display panel 330 when not all are processed within the designated time. For example, on a condition that displaying an image via the display panel 330 is required based on applying all of the second commands, the display driving integrated circuitry 320 in the electronic device 101 may defer providing the second commands to the register 450 until receiving the designated request from the processor 310. For example, on a condition that a synchronization between the second commands and images related to the second commands is required, the display driving integrated circuitry 320 in the electronic device 101 may defer providing the second commands to the register 450 until receiving the designated request from the processor 310. The electronic device 101 may prevent and/or reduce a malfunction from occurring when switching a mode of the electronic device 101 provided through the display panel 330, by including the display driving integrated circuitry 320 executing this operation in various ways illustrated through the descriptions of FIGS. 3 to 14. For example, the electronic device 101 may prevent and/or reduce a malfunction from occurring when changing a resolution of an image displayed through the display panel 330, by including the display driving integrated circuitry 320 executing this operation. For another example, the electronic device 101 may prevent and/or reduce a malfunction from occurring when changing a frame rate, by including the display driving integrated circuitry 320 executing this operation. As another example, by including the display driving integrated circuitry 320, the electronic device 101 may prevent and/or reduce a malfunction from occurring when switching from a normal mode displaying an image through the display panel 330 while a display mode of the electronic device 101 is in a wake-up state to an always on display (AOD) mode displaying an image through the display panel 330 while the processor 310 is in a sleep state, or when switching the display mode from the AOD mode to the normal mode. However, it is not limited thereto.

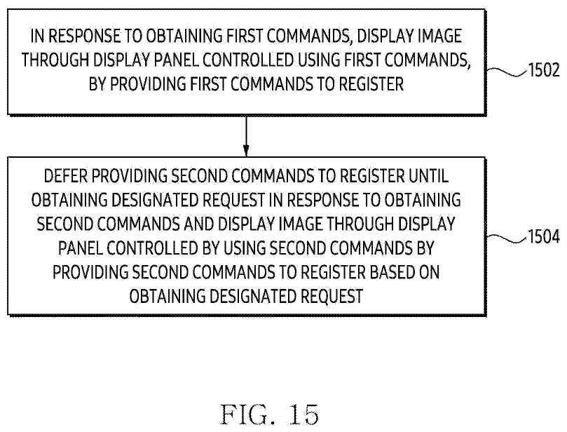

FIG. 15 is a flowchart illustrating a method of deferring commands obtained from a processor. This method may be executed by the display driving integrated circuitry 320 in the electronic device 101 illustrated in FIG. 3.

Referring to FIG. 15, in operation 1502, in response to obtaining first commands from the processor 310, the display driving integrated circuitry 320 may display an image through the display panel 330 controlled using the first commands, by providing the first commands to the register 450. For example, the first commands may be commands that do not require synchronizing with each other, unlike second commands to be described later. For example, the first commands may be commands that do not require controlling a timing provided to the register 450. For example, even when the display driving integrated circuitry 320 does not synchronize processing of a command of the first commands and processing of another command of the first commands, since a malfunction does not appear through the display panel 330, the display driving integrated circuitry 320 may provide each of the first commands to the register 450 as soon as each of the first commands is obtained from the processor 310.

In operation 1504, the display driving integrated circuitry 320 may defer providing the second commands to the register 450 until obtaining a designated request in response to obtaining the second commands from the processor 310, and may display an image through the display panel 330 controlled using the second commands by providing the second commands to the register 450 based on obtaining the designated request. For example, unlike the first commands, the second commands may be commands requiring processing in synchronization with each other. For example, unlike the first commands, the second commands may be commands requiring controlling a timing provided to the register 450. For example, since a malfunction may appear through the display panel 330 when the display driving integrated circuitry 320 does not synchronize processing a command of the second commands and processing another command of the second commands, the display driving integrated circuitry 320 may refrain from providing the second commands to the register 450 by storing each of the second commands in the buffer 456 in response to obtaining each of the second commands from the processor 310. For example, in order to distinguish between a state of storing the second commands obtained from the processor 310 in the buffer 456 and a state of providing the second commands to the register 450 from the buffer 456, the clock signal defined through the description of FIGS. 8 to 14 may be defined in the display driving integrated circuitry 320. However, it is not limited thereto.

In an embodiment, the display driving integrated circuitry 320 may distinguish commands obtained from the processor 310 into the first commands and the second commands, through a flag included in each of the first commands and a flag included in each of the second commands. In an embodiment, the display driving integrated circuitry 320 may distinguish commands obtained from the processor 310 into the first commands and the second commands, according to whether the command obtained from the processor 310 is a command received within a time interval indicated by a designated signal obtained from the processor 310 or received outside the time interval.

In various embodiments, the display driving integrated circuitry 320 may control a timing providing the second commands to the register 450 through various methods. In an embodiment, the display driving integrated circuitry 320 may provide the second commands to the register 450 in response to obtaining the designated request from the processor 310. In an embodiment, the display driving integrated circuitry 320 may provide the second commands to the register 450 based on a start timing of a vertical synchronization signal immediately following a timing of obtaining the designated request from the processor 310. For example, at a timing before a designated time interval from the start timing of the vertical synchronization signal (or a predetermined time interval), providing the register 450 with the second commands may be started. However, it is not limited thereto. In an embodiment, the display driving integrated circuitry 320 may identify whether obtaining a command from the processor 310 for indicating that a transmission of frame data is started based on obtaining the designated request from the processor 310, and provide the second commands to the register 450 in response to obtaining the command. In an embodiment, the display driving integrated circuitry 320 may identify whether a number of commands (e.g., third commands), which are obtained from the processor 310, for indicating that a transmission of frame data is started reaches a predefined number based on obtaining the designated request from the processor 310, and may provide the second commands to the register 450 based on identifying that the number of commands reaches the predefined number. For example, the second commands may be provided to the register 450 based on a start timing of a vertical synchronization signal immediately following a timing identifying that the number of commands (e.g., third commands) reaches the predefined number. However, it is not limited thereto. In an embodiment, the second commands may be provided to the register 450 after a preset time elapses from a timing of obtaining the designated request from the processor 310. However, it is not limited thereto.

In an embodiment, processing of the first commands and processing of the second commands may be independent of each other. For example, the display driving integrated circuitry 320 may store the second commands in the buffer 456 while providing the first commands to the register 450. However, it is not limited thereto.

As described above, the electronic device 101 may seamlessly switch a display mode of the electronic device 101 through the display driving integrated circuitry 320 executing operations illustrated in FIG. 15. For example, the electronic device 101 may prevent and/or reduce a malfunction from being recognized through the display panel 330 by synchronizing processing of the second commands through the display driving integrated circuitry 320.

As described above, according to an example embodiment, an electronic device (e.g., electronic device 101) may comprise: at least one processor, comprising processing circuitry (e.g., the processor 120 or the processor 310), a display panel (e.g., the display panel 330), and display driving integrated circuitry (e.g., the display driving integrated circuitry 320) operably coupled with each of the at least one processor and the display panel. According to an example embodiment, the display driving integrated circuitry may be configured to: in response to obtaining first commands from the at least one processor, display, by providing the first commands to a register (e.g., the register 450) in the display driving integrated circuit, an image through the display panel controlled using the first commands. According to an example embodiment, the display driving integrated circuitry may be configured to: in response to obtaining second commands from the at least one processor, defer providing the second commands to the register until obtaining a designated request from the at least one processor. According to an example embodiment, the display driving integrated circuitry may be configured to: display, by providing the second commands to the register based on obtaining the designated request from the at least one processor, an image through the display panel controlled using the second commands.

According to an example embodiment, the display driving integrated circuitry may be configured to: defer providing the second commands to the register by storing the second commands in a buffer (e.g., the buffer 456) in the display driving integrated circuitry before obtaining the designated request. For example, an order of providing the second commands to the register may be identified based on order in which the second commands are stored. For example, each of the second commands stored in the buffer may include address information, and the order of providing the second commands to the register may be identified based on the address information.

According to an example embodiment, each of the first commands may include a flag of a first state, and each of the second commands may include a flag of a second state.

According to an example embodiment, the display driving integrated circuitry may be configured to: defer, while a state of a signal for controlling a timing providing the second commands to the register is a first state, providing the second commands to the register. According to an example embodiment, the display driving integrated circuitry may be configured to switch, in response to obtaining the designated request while deferring providing the second commands, the state of the signal from the first state to a second state. According to an example embodiment, the display driving integrated circuitry may be configured to provide, in response to switching the state of the signal from the first state to the second state, the second commands to the register.

According to an example embodiment, the display driving integrated circuitry may be configured to provide, in response to obtaining the designated request, the second commands to the register.

According to an example embodiment, the display driving integrated circuitry may be configured to provide, based on a start timing of a vertical synchronization signal immediately following a timing obtaining the designated request, the second commands to the register. For example, the display driving integrated circuitry may be configured to initiate providing, at a timing before a designated time interval from a start timing of the vertical synchronization signal, the second commands to the register.

According to an example embodiment, the display driving integrated circuitry may be configured to, based on obtaining the designated request, identify whether obtaining a command indicating that a transmission of frame data from the at least one processor is started. According to an example embodiment, the display driving integrated circuitry may be configured to, in response to obtaining the command, provide the second commands to the register.

According to an example embodiment, the display driving integrated circuitry may be configured to, based on obtaining the designated request, identify whether a number of commands indicating that a transmission of frame data is started reaches a designated number, the command obtained from the at least one processor. According to an example embodiment, the display driving integrated circuitry may be configured to provide, based on a start timing of a vertical synchronization signal immediately following a timing identifying that the number of commands reaches the designated number, the second commands to the register.

According to an example embodiment, the display driving integrated circuitry may be configured to provide the second commands to the register, after a designated time elapses from a timing obtaining the designated request.

According to an example embodiment, the display driving integrated circuitry may be configured to, based on obtaining the designated request, identify whether a number of commands indicating that a transmission of frame data is started reaches a designated number, the command obtained from the at least one processor. According to an example embodiment, the display driving integrated circuitry may be configured to provide, after a designated time elapses from identifying that the identified number reaches the designated number, the second commands to the register.

According to an example embodiment, the display driving integrated circuitry may be configured to defer providing the second commands to the register while providing the first commands to the register.

According to an example embodiment, the display driving integrated circuitry may be configured to, in response to obtaining third commands from the at least one processor, defer, until obtaining another designated request from the at least one processor, providing the third commands to the register. According to an example embodiment, the display driving integrated circuitry may be configured to display, by providing the third commands to the register based on obtaining the other designated request from the at least one processor, an image through the display panel controlled using the third commands. For example, the display driving integrated circuitry may be configured to provide, in response to obtaining the designated request, the second commands to the register. For example, the display driving integrated circuitry may be configured to provide, after a designated time elapses from obtaining the other designated request, the third commands to the register.

According to an example embodiment, the display driving integrated circuitry may include a buffer and a control circuit configured to identify whether a command is provided from the at least one processor to the register or to the buffer. According to an example embodiment, the display driving integrated circuitry may be configured to, using the control circuit, provide the first commands obtained from the at least one processor to the register. According to an example embodiment, the display driving integrated circuitry may be configured to, using the control circuit, defer, by storing the second commands obtained from the at least one processor in the buffer, providing the second commands to the register. For example, the display driving integrated circuitry may include another control circuit configured to provide a command provided from the at least one processor or a command provided from the buffer to the register. For example, each of the first commands may be provided through the control circuit and the other control circuit from the at least one processor to the register. For example, each of the second commands obtained from the at least one processor may be stored in the buffer through the control circuit. For example, each of the second commands stored in the buffer may be provided through the other control circuit to the register, based on the designated request.

According to an example embodiment, the at least one processor, individually and/or collectively, may be configured to identify a request changing a resolution of an image displayed through the display panel. According to an example embodiment, the at least one processor, individually and/or collectively, may be configured to provide, based on the identification, the second commands to the display driving integrated circuitry.

According to an example embodiment, the display driving integrated circuitry may be configured to defer, by storing the second commands in a buffer in the display driving integrated circuitry before obtaining the designated request, providing the second commands to the register. According to an example embodiment, the display driving integrated circuitry may be configured to provide, based on obtaining the designated request, the second commands stored in the buffer to the register. According to an example embodiment, the display driving integrated circuitry may be configured to provide, in response to obtaining the designated request, a first signal indicating ceasing obtaining commands to be stored in the buffer from the at least one processor, to the at least one processor. According to an example embodiment, the display driving integrated circuitry may be configured to provide, in response to identifying that providing the second commands to the register is completed, a second signal indicating resuming obtaining the commands to be stored in the buffer from the at least one processor, to the at least one processor.

According to various example embodiments, an electronic device and a method can prevent and/or reduce a malfunction from occurring in a display panel of the electronic device, by deferring providing commands to a register until a designated request is received from a processor.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a memory;
at least one processor, comprising processing circuitry;
display driving integrated circuitry operably coupled with the at least one processor; and
a display panel operably coupled with the display driving integrated circuitry,
wherein the memory stores instructions causing the display driving integrated circuitry to:
in response to obtaining first commands from the at least one processor, display, by providing the first commands to a register in the display driving integrated circuitry, an image through the display panel controlled using the first commands; and
in response to obtaining second commands from the at least one processor, defer providing the second commands to the register until obtaining a designated request from the at least one processor, and display, by providing the second commands to the register based on obtaining the designated request from the at least one processor, an image through the display panel controlled using the second commands.

2. The electronic device of claim 1, wherein the memory stores instructions causing the display driving integrated circuitry to defer providing the second commands to the register by storing the second commands in a buffer in the display driving integrated circuitry before obtaining the designated request.

3. The electronic device of claim 2, wherein an order of providing the second commands to the register is identified based on order in which the second commands are stored.

4. The electronic device of claim 2, wherein each of the second commands stored in the buffer includes address information, and
wherein an order of providing the second commands to the register is identified based on the address information.

5. The electronic device of claim 1, wherein each of the first commands includes a flag of a first state, and
wherein each of the second commands includes a flag of a second state.

6. The electronic device of claim 1, wherein the memory stores instructions causing the display driving integrated circuitry to:
defer, while a state of a signal for controlling a timing providing the second commands to the register is a first state, providing the second commands to the register;
switch, in response to obtaining the designated request while deferring providing the second commands, the state of the signal from the first state to a second state; and
provide, in response to switching the state of the signal from the first state to the second state, the second commands to the register.

7. The electronic device of claim 1, wherein the memory stores instructions causing the display driving integrated circuitry to:
provide, in response to obtaining the designated request, the second commands to the register.

8. The electronic device of claim 1, wherein the memory stores instructions causing the display driving integrated circuitry to:
provide, based on a start timing of a vertical synchronization signal following a timing obtaining the designated request, the second commands to the register.

9. The electronic device of claim 8, wherein the memory stores instructions causing the display driving integrated circuitry to:
initiate providing, at a timing before a designated time interval from a start timing of the vertical synchronization signal, the second commands to the register.

10. The electronic device of claim 1, wherein the memory stores instructions causing the display driving integrated circuitry to:
based on obtaining the designated request, identify whether obtaining a command indicating that a transmission of frame data from the at least one processor is started; and
in response to obtaining the command, provide the second commands to the register.

11. The electronic device of claim 1, wherein the memory stores instructions causing the display driving integrated circuitry to:
based on obtaining the designated request, identify whether a number of commands indicating that a transmission of frame data is started reaches a designated number, obtaining the command from the at least one processor; and
provide, based on a start timing of a vertical synchronization signal following a timing identifying that the number of commands reaches the designated number, the second commands to the register.

12. The electronic device of claim 1, wherein the memory stores instructions causing the display driving integrated circuitry to:
provide the second commands to the register, after a designated time elapses from a timing obtaining the designated request.

13. The electronic device of claim 1, wherein the memory stores instructions causing the display driving integrated circuitry to:
based on obtaining the designated request, identify whether a number of commands indicating that a transmission of frame data is started reaches a designated number, obtaining the command from the at least one processor; and
provide, after a designated time elapses from identifying that the identified number reaches the designated number, the second commands to the register.

14. The electronic device of claim 1, wherein the memory stores instructions causing the display driving integrated circuitry to:
defer providing the second commands to the register while providing the first commands to the register.

15. The electronic device of claim 1, wherein the memory stores instructions causing the display driving integrated circuitry to:
in response to obtaining third commands from the at least one processor, defer, until obtaining another designated request from the at least one processor, providing the third commands to the register; and
display, by providing the third commands to the register based on obtaining the other designated request from the at least one processor, an image through the display panel controlled using the third commands.

16. The electronic device of claim 15, wherein the memory stores instructions causing the display driving integrated circuitry to:
provide, in response to obtaining the designated request, the second commands to the register; and
provide, after a designated time elapses from obtaining the other designated request, the third commands to the register.

17. The electronic device of claim 1, wherein the display driving integrated circuitry includes:
a buffer; and
a control circuit configured to identify whether a command is provided from the at least one processor to the register or to the buffer,
wherein the memory stores instructions causing the display driving integrated circuitry to:
using the control circuit, provide the first commands obtained from the at least one processor to the register; and
using the control circuit, defer, by storing the second commands obtained from the at least one processor in the buffer, providing the second commands to the register.

18. The electronic device of claim 18, wherein the memory stores instructions causing the display driving integrated circuitry to:
provide a command provided from the at least one processor or a command provided from the buffer to the register,
wherein each of the first commands is provided through the control circuit and the other control circuit from the at least one processor to the register,
wherein each of the second commands obtained from the at least one processor is stored in the buffer through the control circuit, and
wherein the each of the second commands stored in the buffer is provided through the other control circuit to the register, based on the designated request.

19. The electronic device of claim 1, wherein the memory stores instructions causing the processor to:
identify a request changing a resolution of an image displayed through the display panel; and
provide, based on the identification, the second commands to the display driving integrated circuitry.

20. The electronic device of claim 1, wherein the memory stores instructions causing the display driving integrated circuitry to:
defer, by storing the second commands in a buffer in the display driving integrated circuitry before obtaining the designated request, providing the second commands to the register;
provide, based on obtaining the designated request, the second commands stored in the buffer to the register;
provide, in response to obtaining the designated request, a first signal indicating ceasing obtaining commands to be stored in the buffer from the at least one processor, to the at least one processor; and
provide, in response to identifying that providing the second commands to the register is completed, a second signal indicating resuming obtaining the commands to be stored in the buffer from the at least one processor, to the at least one processor.
